(19) United States
(12) Patent Application Publication
(10) Pub. No.: US 2021/0131423 A1
(43) Pub. Date: May 6, 2021

(54) FLOW CAGE

(71) Applicant: Schlumberger Technology Corporation, Sugar Land, TX (US)

(72) Inventors: Christopher Valenzuela, Odessa, TX (US); Edward Guerrero, Odessa, TX (US); Denys LeBlanc, Midland, TX (US); Yuteng Liang, Houston, TX (US); Charles Fisher, Midland, TX (US)

(21) Appl. No.: 17/085,707

(22) Filed: Oct. 30, 2020

Related U.S. Application Data
(60) Provisional application No. 62/928,132, filed on Oct. 30, 2019.

(51) Int. Cl. F04B 53/10; E21B 43/12; F16K 27/02

(52) U.S. Cl. CPC F04B 53/1007; E21B 2200/04; F16K 27/0209; E21B 43/126

(57) ABSTRACT

A valve assembly for an artificial lift system can include a cage defining a bore therethrough, a valve seat, and a ball disposed within the cage. In a closed position, the ball seals against the valve seat. Upon application of sufficient pressure, the ball lifts from the valve seat to open the valve and allow fluid to flow through the bore. An interior surface of the cage surrounding the bore includes a flow profile that improves fluid flow through the cage. The flow profile can include a plurality of flanges protruding inwardly into the bore from the interior surface and extending helically along a longitudinal length of the cage.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. The present application claims priority benefit of U.S. Provisional Application No. 62/928,132, filed Oct. 30, 2019, the entirety of which is incorporated by reference herein and should be considered part of this specification.

### BACKGROUND

### Field

The present disclosure generally relates to components for artificial lift in oil and gas wells, and more particularly to flow cages for sucker rod pumps.

### Description of the Related Art

Oil and gas wells utilize a borehole drilled into the earth and subsequently completed with equipment to facilitate production of desired fluids from a reservoir. Subterranean fluids, such as oil, gas, and water, are produced from the wellbore. In some cases, the fluid is produced to the surface naturally by downhole formation pressures. However, the fluid must often be artificially lifted from wellbores by the introduction of downhole equipment. Various types of artificial lift are available. In a rod pump system, a beam and crank assembly is located at the surface of a well to provide power to a downhole pump assembly. The pump includes a plunger and valve assembly. A rod string, including sucker rods, connects the surface components to the pump. The beam and crank assembly creates reciprocating motion in the rod string, and the pump converts the reciprocating motion to vertical movement of the fluid being pumped.

### SUMMARY

In some configurations, a valve assembly for an artificial lift system includes a tubular cage body comprising a wall defining a bore therethrough; a valve seat; a ball disposed within the cage body and configured to seal against the valve seat when the valve assembly is in a closed position; and a flow profile in or on an inner surface of the wall of the cage body.

The flow profile can include a plurality of flanges protruding inwardly into the bore from the inner surface of the wall and extending helically along a longitudinal length of the cage body. The flow profile can include a plurality of flanges protruding inwardly into the bore from the inner surface of the wall and extending at an angle or curving along a longitudinal length of the cage body. The valve assembly can further include a ball stop extending across the bore at a location above and longitudinally spaced from the valve seat, the ball stop configured to limit movement of the ball when the valve assembly is in an open position. A portion of the flanges can project inwardly into the bore toward each other to form the ball stop. A center of the ball stop aligned along a central longitudinal axis of the cage body can be bored out. The flanges can extend longitudinally above the ball stop or end just above and proximate the ball stop. The flow profile can be machined or casted into the inner surface of the wall of the cage body.

The cage body can include one or more of alloy steel, carbon steel, stainless steel, monel, and stellite. The cage body can be hardened or coated. The flow profile can be coated, hard lined, or surface treated.

In some configurations, a method of manufacturing a valve for a sucker rod pump system includes forming a tubular cage body defining a bore therethrough; and machining or casting a flow profile into an interior surface of the tubular cage body. The flow profile can include a plurality of flanges protruding inwardly into the bore from the interior surface of the tubular cage body and extending helically along a longitudinal length of the tubular cage body. Forming the tubular cage body can include hardening and/or coating the tubular cage body.

Forming the tubular cage body can include hardening and/or coating the tubular cage body. The flow profile can include a plurality of flanges protruding inwardly into the bore from the interior surface of the tubular cage body and extending helically, at an angle, or curving along a longitudinal length of the tubular cage body. A portion of the plurality of flanges can extend into the bore toward each other to form a ball stop for a ball disposed in the cage body in use. The method can further include machining or casting out a central portion of the ball stop aligned along a central longitudinal axis of the cage body to form a central bore in the ball stop. The tubular cage body can be formed of one or more of alloy steel, carbon steel, stainless steel, monel, and stellite, The method can further include coating, hard lining, and/or surface treating the flow profile.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 shows a cross-sectional view of an example embodiment of a cage for a valve assembly.

FIG. 2 shows a downhole portion of an example insert rod pump design.

FIG. 3 shows a cross-sectional view of an example embodiment of a cage for a valve assembly.

FIG. 4 shows a cross-sectional view of an example embodiment of a cage for a valve assembly.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

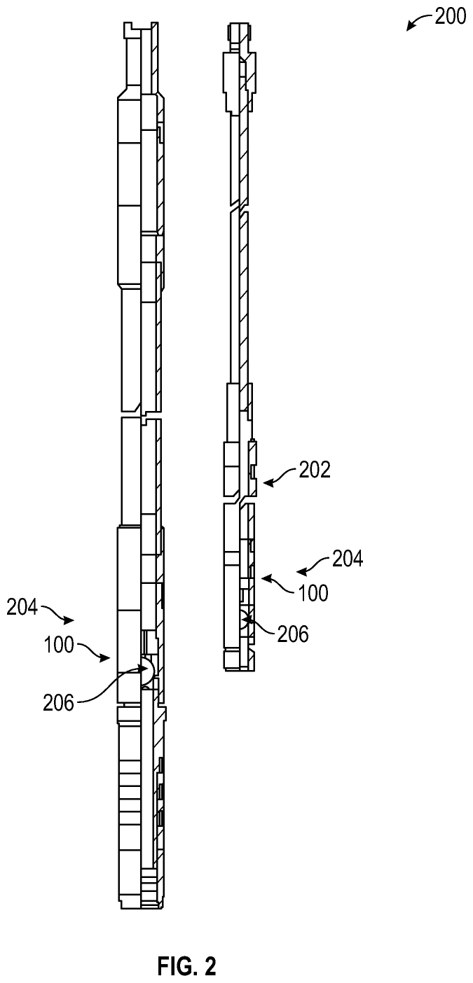

In a rod pump system, a beam and crank assembly is located at the surface of a well to provide power to a downhole pump assembly 200 (shown in FIG. 2). The pump includes a plunger 202 and valve assembly 204. A rod string, including sucker rods, connects the surface components to the pump 200. The beam and crank assembly creates reciprocating motion in the rod string, and the pump 200 converts the reciprocating motion to vertical movement of the fluid being pumped.

The valve assembly 204 can include a ball and seat valve. The valve includes a generally cylindrical and/or tubular cage having a bore 104 therethrough. In use, the cage is typically oriented vertically. The valve also includes a valve seat and a ball 206 disposed within the cage. The valve seat can extend across, e.g., transversely across, the bore 104 of the cage to form a seat for the ball 206. Alternatively, the valve seat can be formed or defined by a portion of the cage or a ring shaped component having an internal diameter less than a diameter of the ball. In use, when the cage is oriented vertically, the valve seat extends horizontally and may be disposed at or near the bottom of the cage or bore 104. In some configurations, the valve includes a ball stop extending across, e.g., transversely across the bore 104 of the cage. When the cage is oriented vertically, the ball stop extends horizontally and may be disposed at or near the top of the cage or bore 104.

The ball 206 is disposed in a space defined by the cage, valve seat, and ball stop. In use, in a closed position, the ball rests on the valve seat to close the bore. When sufficient pressure is applied beneath the ball, the ball lifts away from the seat to an open position, and fluid can flow through the bore. Upward movement or travel of the ball is limited by the ball stop.

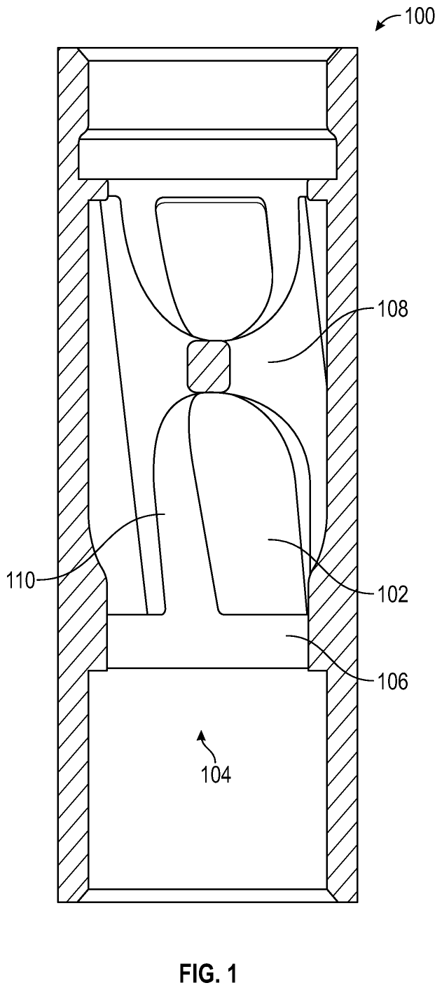

In cages 100 according to the present disclosure, for example as shown in FIG. 1, an interior surface 102 of the cage 100 (e.g., a tubular wall defining the cage) includes a profile that enhances fluid flow, for example, improves or increases volumetric flow, through the valve. In some configurations, the flow profile effects desirable flow patterns through the cage 100 and/or pressure drop characteristics across the cage 100. In some configurations, the flow profile has a generally helical pattern. The flow profile can be defined by or include flanges 110 protruding inwardly into the bore 104 from the interior surface 102 of the cage. The flanges 110 can be machined or casted in or on the interior surface 102. In other words, the flanges 110 are integral or monolithic with the cage 100 body. The flanges 110 can extend at an angle longitudinally along the cage 100 or can extend longitudinally along the cage 100 while curving, e.g., helically curving, about the longitudinal axis around the interior surface 102. In use, the flanges 110 can direct fluid flowing through the cage 100, causing the fluid to swirl. The cage 100 can support both or either an API (standard) and/or a non-API (alternate) ball and seat.

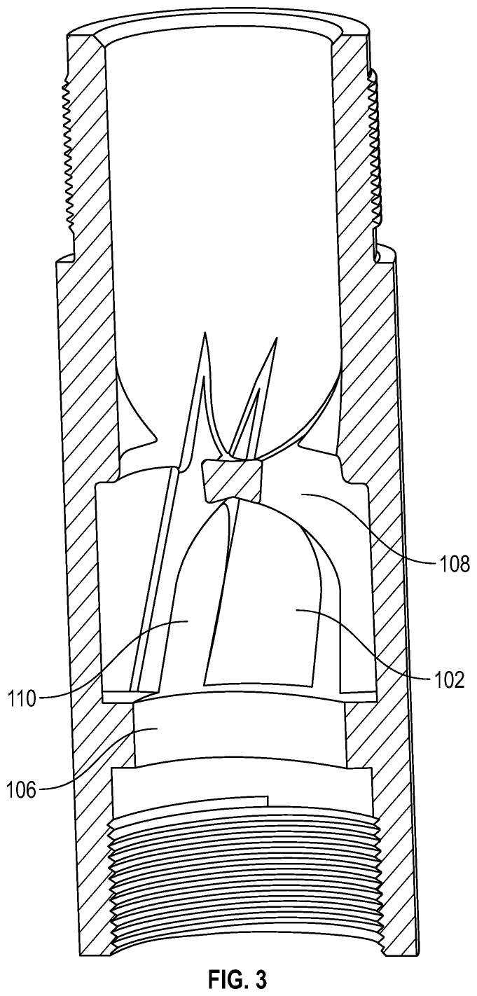

In some configurations, a portion of the flanges 110 can arch and/or extend inwardly into the bore 104 and come together or meet to form the ball stop 108 or a portion thereof. In some such configurations, the ball stop 108 is formed at, near, and/or by a longitudinal midpoint or midportion of the flanges 110, for example as shown in FIG. 1. In other words, the flanges 110 can extend from the valve seat 106 and extend above the ball stop 108. In other configurations, the flanges 110 can extend from the valve seat 106 but extend only to about or slightly above or beyond the ball stop 108, for example as shown in FIG. 3. The ball stop 108 can therefore be formed by a portion of the flanges 110 at or near a top of the flanges 110. Such a configuration with the flanges 110 stopping around the ball stop 108 or around a longitudinally central portion of the cage 100 can advantageously help improve control of fluid flow through the valve. For example, ending the flanges 110 near the ball stop 108 and/or a longitudinal midportion of the cage 100 can help centralize the flow and/or increase the flow rate as the flow continues to move upward through the cage 100.

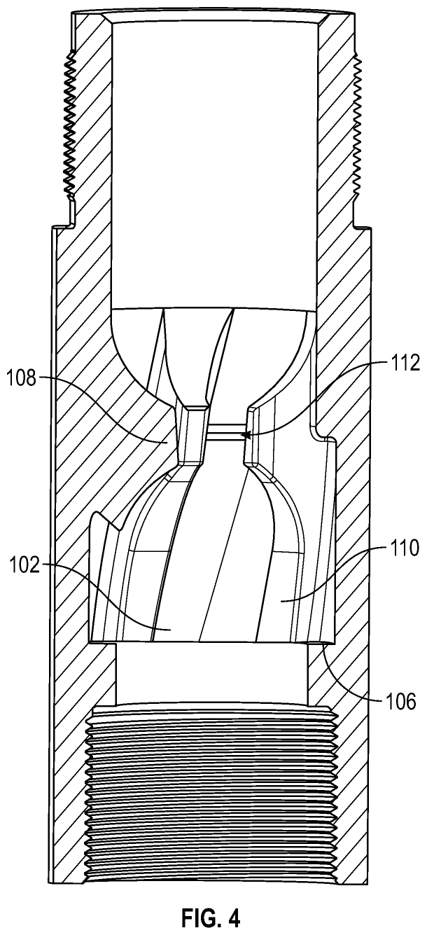

In some configurations, the ball stop 108 has a bored out central portion 112, for example as shown in FIG. 4. The bored out central portion 112 can be machined or casted out. A bored out central portion 112 can advantageously help improve flow through the valve and/or reduce the amount of material needed for the cage 100.

One or more cages 100 according to the present disclosure can be used in rod pump assemblies, for example as shown in FIG. 2. A cage 100 can be used in a standing valve of a rod pump assembly that is stationary during operation, as shown on the left side of FIG. 2. A cage 100 can be used in a traveling valve in the reciprocating or traveling assembly of a rod pump assembly, as shown in the right side of FIG. 2.

Compared to a valve design including an insert disposed within a cage, with the insert including a profile to direct fluid flow through the valve, the valve design described herein having a flow profile machined or casted directly into an inner surface of the cage 100 advantageously allows the valve to have fewer parts or components, which can simplify assembly of the valve. Having the flow profile machined directly into the cage, compared to in an insert disposed within the cage, can advantageously increase the flow area through the valve and/or allow for a more effective or efficient flow path, which can reduce ball chatter due to cyclical movement of the ball within the cage during use. Cages according to the present disclosure can reduce or decrease wear on the internal flow profile due to cyclical movement of the ball within the cage.

The cage 100 can be made of or include a hard material, or a soft material that is case/depth hardened and/or coated. For example, the cage 100 can be made of or include one or more of alloy steel, carbon steel, stainless steel, monel, stellite, and/or other suitable materials. The internal flow profile is casted or machined into the interior surface 102 of the cage wall. The internal flow profile can be coated, hard lined, and/or surface treated, for example, to provide improved wear properties.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A valve assembly for an artificial lift system, the valve assembly comprising:
a tubular cage body comprising a wall defining a bore therethrough;
a valve seat;
a ball disposed within the cage body and configured to seal against the valve seat when the valve assembly is in a closed position; and
a flow profile formed in or on an inner surface of the wall of the cage body.

2. The valve assembly of claim 1, the flow profile comprising a plurality of flanges protruding inwardly into the bore from the inner surface of the wall and extending helically along a longitudinal length of the cage body.

3. The valve assembly of claim 1, the flow profile comprising a plurality of flanges protruding inwardly into the bore from the inner surface of the wall and extending at an angle or curving along a longitudinal length of the cage body.

4. The valve assembly of claim 1, further comprising a ball stop extending across the bore at a location above and longitudinally spaced from the valve seat, the ball stop configured to limit movement of the ball when the valve assembly is in an open position.

5. The valve assembly of claim 4, the flow profile comprising a plurality of flanges protruding inwardly into the bore from the inner surface of the wall and extending at an angle or curving along a longitudinal length of the cage body, wherein a portion of the flanges project inwardly into the bore toward each other to form the ball stop.

6. The valve assembly of claim 5, wherein a center of the ball stop aligned along a central longitudinal axis of the cage body is bored out.

7. The valve assembly of claim 4, the flow profile comprising a plurality of flanges protruding inwardly into the bore from the inner surface of the wall and extending at an angle or curving along a longitudinal length of the cage body, wherein the flanges end above and proximate the ball stop.

8. The valve assembly of claim 4, wherein a center of the ball stop aligned along a central longitudinal axis of the cage body is bored out.

9. The valve assembly of claim 1, wherein the flow profile is machined or casted into the inner surface of the wall of the cage body.

10. The valve assembly of claim 1, the cage body comprising one or more of alloy steel, carbon steel, stainless steel, monel, and stellite.

11. The valve assembly of claim 1, wherein the flow profile is coated, hard lined, or surface treated.

12. The valve assembly of claim 1, wherein the cage body is hardened or coated.

13. A method of manufacturing a valve for a sucker rod pump system, the method comprising:
forming a tubular cage body defining a bore therethrough; and
machining or casting a flow profile into an interior surface of the tubular cage body.

14. The method of claim 13, wherein forming the tubular cage body comprises hardening the tubular cage body.

15. The method of claim 13, wherein forming the tubular cage body comprises coating the tubular cage body.

16. The method of claim 13, wherein the flow profile comprises a plurality of flanges protruding inwardly into the bore from the interior surface of the tubular cage body and extending helically, at an angle, or curving along a longitudinal length of the tubular cage body.

17. The method of claim 16, wherein a portion of the plurality of flanges extending into the bore toward each other to form a ball stop for a ball disposed in the cage body in use.

18. The method of claim 17, further comprising machining or casting out a central portion of the ball stop aligned along a central longitudinal axis of the cage body to form a central bore in the ball stop.

19. The method of claim 13, wherein forming the tubular cage body comprises forming the tubular cage body of one or more of alloy steel, carbon steel, stainless steel, monel, and stellite.

20. The method of claim 13, further comprising coating, hard lining, and/or surface treating the flow profile.
